(19) United States
(12) Patent Application Publication
(10) Pub. No.: US 2022/0126130 A1
(43) Pub. Date: Apr. 28, 2022

(54) FILTER MASK

(71) Applicant: ACRP Limited, Kitchener (CA)

(72) Inventors: Ming Zhang, Waterloo (CA); Nick Allen, Kitchener (CA); Cuixian Liu, Waterloo (CA)

(21) Appl. No.: 17/510,916

(22) Filed: Oct. 26, 2021

Related U.S. Application Data
(60) Provisional application No. 63/106,205, filed on Oct. 27, 2020.

(51) Int. Cl. A62B 23/02; A41D 13/11; A62B 18/08; B01D 46/52

(52) U.S. Cl. CPC A62B 23/02; A41D 13/11; B01D 2279/40; B01D 46/521; A62B 18/084

(57) ABSTRACT

A filter mask, including a flexible filtering mask body having an outside surface and an opposite inside surface shaped to cover a nose and a mouth of a user, the mask body having a midbody portion extending between a right body side and a left body side. The filtering mask body is moveable between a first configuration having a first horizontal extent of the outside surface along the midbody portion and a second configuration in having a second horizontal extent of the outside surface along the midbody portion, the second extent being greater than the first extent. The filter mask includes a retainer system to hold the mask body to a user's head, the retainer system arranged to draw at only a single left-side location and only a single right-side location of the mask body when used reconfigure the filtering mask body from the first configuration to the second configuration.

### CROSS-REFERENCE

The present application claims benefit of U.S. Provisional Patent Application No. 63/106,205 entitled FILTER MASK, filed Oct. 27, 2020, the entirety of which is incorporated herein by reference.

### TECHNICAL FIELD

The disclosure relates to masks, and in particular, to a pleated filter mask.

### BACKGROUND

A filter mask can be used to protect a wearer and/or others from contaminants in the air that is breathed in and/or out by the wearer. A filter mask includes a filter made of a gas-permeable filtering media through which at least some of the air that is breathed in and/or out by the wearer may pass.

A filtering mask may be a face mask in that the filter is part of a loose-fitting (i.e. not including a respirator-style non-porous face seal to seal against the face of the wearer) mask body to be positioned over a nose and a mouth of the wearer. Alternatively, a filtering mask may be a respirator mask in that the mask incorporates a facial seal portion arranged to seal against the face of the wearer.

It is generally desirable that a filtering mask be easily manufactured, stored, and/or transported. It is also generally desirable that the filtering mask be put on by the wearer and worn comfortably with minimal tactile contact between the hands of the wearer and the filter and/or mask body (e.g. since such contact may trouble the wearer, reduce the willingness of the wearer to wear the mask, and/or reduce the effectiveness of the filtering mask). However, many filtering masks are difficult to position over the mouth and nose of the wearer comfortably without such undesirable tactile contact. This is particularly the case with face masks, since the loose-fitting (i.e. not including a respirator-style non-porous face seal to seal against the face of the wearer) mask body is generally flexible and yet needs to be formed into a cup-shape to rest comfortably over the nose and mouth of the wearer.

Attempts have been made to design filtering masks which can be put on and worn comfortably with minimal tactile contact between the hands of the wearer and the filter and/or mask body. For example, U.S. Pat. No. 3,664,335 to Boucher et al. (“Boucher”) discloses a disposable surgical face mask comprising a flexible porous pad capable of covering the nose and the mouth of the wearer. The flexible porous pad disclosed by Boucher has a first vertical double pleat structure and a second vertical double pleat structure. The first and second vertical double pleat structures of Boucher are parallel to one another and are spaced a horizontal distance from one another. The vertical double pleat structures of Boucher form a cavity on the inner side of the flexible porous pad. When the frontal face of the flexible porous pad of Boucher is extended outwardly, the vertical double pleat structures expand and provide a semi-rigid box structure.

However, Boucher discloses that binding tapes are stitched into the horizontal edges of the flexible porous pad and an elastic binding is secured onto each vertical edge of the flexible porous pad. These features of Boucher reduce the ease of manufacturing the face mask and/or necessitate undesirable tactile contact between the wearer and the mask body to form and/or maintain the cup-shape.

Accordingly, there remains a need for improved filter masks.

### SUMMARY

According to a first aspect, there is provided a filter mask for covering a nose and a mouth of a user, comprising a flexible mask body formed of a gas-permeable filter medium and shaped to cover the nose and the mouth of the user, the mask body having a top body portion at a top body end to be adjacent the nose of the user when the filter mask is worn, a bottom body portion at a bottom body end opposite the top body end to be adjacent a chin of the user when the filter mask is worn, a midbody portion positioned between the top body end and the bottom body end and extending between a right body side and a left body side opposite the right body side, a plurality of pleats, each pleat having a top pleat end at the top body end and bottom pleat end at the bottom body end and extending between the top body end and the bottom body end across the midbody portion, each pleat having at least one of the top pleat end and the bottom pleat end fixed shut, and each pleat openable in the midbody portion, and wherein the filtering mask body is extendable between a first configuration in which each of the plurality of pleats are closed in the midbody portion and the mask body has a first horizontal extent of the outside surface along the midbody portion and a second configuration in which the plurality of pleats are open in the midbody portion and the mask body has a second horizontal extent of the outside surface along the midbody portion, the second extent being greater than the first extent; and a retainer system to retain the filter mask on the head of the user, the retainer system secured to the mask body only at a single right-side location and a single left-side location, the retainer system including at least one flexible strap including at least one right strap end secured to the filtering mask body at the right-side location, and the at least one flexible strap including at least one left strap end secured to the filtering mask body at the left-side location.

In some examples, each of the top pleat end and the bottom pleat end of each pleat is fixed shut, and each pleat is openable in the midbody portion.

The left-side location and the right-side location may be diametrically opposed across the midbody portion such that the midbody portion is drawn open along a horizontal midway line running across the midbody portion between the right-side location and the left-side location when the right-side location and the left-side location are moved apart.

The midway line may be a horizontal centerline of the midbody portion, spaced an equal distance from the top body end and the bottom body end.

The at least one flexible strap may include a right ear loop and a left ear loop, the right ear loop having right first and second ends secured to the filtering mask body adjacent one another and at the right-side location, and the left ear loop having left first and second ends secured to the filtering mask body adjacent one another and at the left-side location.

The right first and second ends and the left first and second ends may be secured to the outside face of the filtering mask body.

The retainer system may consist only of the right ear loop and the left ear loop.

The mask body may be a single generally planar panel in the first configuration with the left-side location and the right-side location separated by a distance that is at least 50% of the first horizontal extent.

The mask body may be configured to be loose-fitting (i.e. not including a respirator-style non-porous face seal to seal against the face of the wearer) over the nose and the mouth of the user.

The mask body may have a vertical axis along which the top body portion and the bottom body portion are separated, and each pleat may be a vertical pleat parallel to the vertical axis, and the plurality of pleats may be evenly distributed about a vertical center line of the mask body.

Each pleat of the plurality of pleats may include an inner fold and an outer fold farther from a vertical centerline of the filtering mask body than the inner fold.

According to a second aspect, there is provided a filter mask for covering a nose and a mouth of a user, comprising a flexible mask body formed of a gas-permeable filter medium and shaped to cover the nose and the mouth of the user, the mask body having an outside surface and an opposite inside surface, the mask body having a top body portion at a top body end to be adjacent the nose of the user when the filter mask is worn, a bottom body portion at a bottom body end opposite the top body end to be adjacent a chin of the user when the filter mask is worn, and a midbody portion positioned between the top body end and the bottom body end and extending between a right body side and a left body side opposite the right body side, and wherein the mask body is extendable between a first configuration in which the mask body has a first horizontal extent of the outside surface along the midbody portion and a second configuration in which the mask body has a second horizontal extent of the outside surface along the midbody portion, the second extent being greater than the first extent; and a retainer system secured to the mask body and shaped to retain the mask body to a head of the user over the nose and the mouth of the user with the top body end above the bottom body end, wherein the retainer system is attached to the mask body and arranged to draw at only a single left-side location on the left body side and only a single right-side location on the right body side when a right portion of the retainer system and a left portion of the retainer system are moved apart to reconfigure the mask body from the first configuration to the second configuration.

In some examples, at least one of a top edge of the outside surface along the top body end and a bottom edge of the outside surface along the bottom body end has a first fixed length in both the first and second configurations.

The top edge may have the first fixed length in both the first and second configurations, and the bottom edge may have a second fixed length in both the first and second configurations.

A perimeter of the mask body may have a fixed length in both the first and second configurations.

The left-side location and the right-side location may be diametrically opposed across the midbody portion such that the midbody portion is drawn open along a horizontal midway line running across the midbody portion between the right-side location and the left-side location when the right portion of the retainer system and the left portion of the retainer system are moved apart.

The retainer system may include at least one flexible strap, the at least one flexible strap including at least one right strap end secured to the filtering mask body at the right-side location, and the at least one flexible strap including at least one left strap end secured to the filtering mask body at the left-side location.

The left-side location and the right-side location may be separated in the first configuration by a first distance that is at least 50% of the first horizontal extent.

The filtering mask body may include a plurality of pleats, each pleat of the plurality of pleats extending between the top body end and the bottom body end.

A right height of the filtering mask body at the right side and a left height of the filtering mask body at the left side may be each less than a center height of the filtering mask body along a vertical center line of the filtering mask body.

According to a third aspect, there is provided a method of applying a face mask, comprising providing the face mask having a mask body of a flexible gas-permeable filter medium, a right ear loop secured to the mask body at a single-right-side location, and a left ear loop secured to the mask body at a single left-side location, the mask body extendable horizontally when drawn from the single right-side location and the single left-side location; drawing the right ear loop and the left ear loop apart to increase an outside surface horizontal extent of the mask body; positioning the filtering mask body over a nose and a mouth of a user; and positioning the right side ear loop over a right ear of the user and the left side ear loop over a left ear of the user.

### BRIEF DESCRIPTION OF THE DRAWINGS

The drawings included herewith are for illustrating various examples of systems, methods, and apparatus of the present specification. In the drawings:

FIG. 1 is first front perspective view of a filter mask in a first configuration;

FIG. 2 is a first front perspective view of the filter mask of FIG. 1 in a second configuration;

FIG. 3 is a front elevation view of the filter mask of FIG. 1 in the first configuration;

FIG. 4 is a rear elevation view of the filter mask of FIG. 1 in the first configuration;

FIG. 5 is a second front perspective view of the filter mask of FIG. 1 in the first configuration;

FIG. 6 a second front perspective view of the filter mask of FIG. 1 in the second configuration;

FIG. 7 a rear perspective view of the filter mask of FIG. 1 in the second configuration; and

FIG. 8 is a flow chart of a method of applying a filter mask.

### DETAILED DESCRIPTION

Various apparatus or processes will be described below to provide an example of each claimed embodiment. No example described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatus or processes described below.

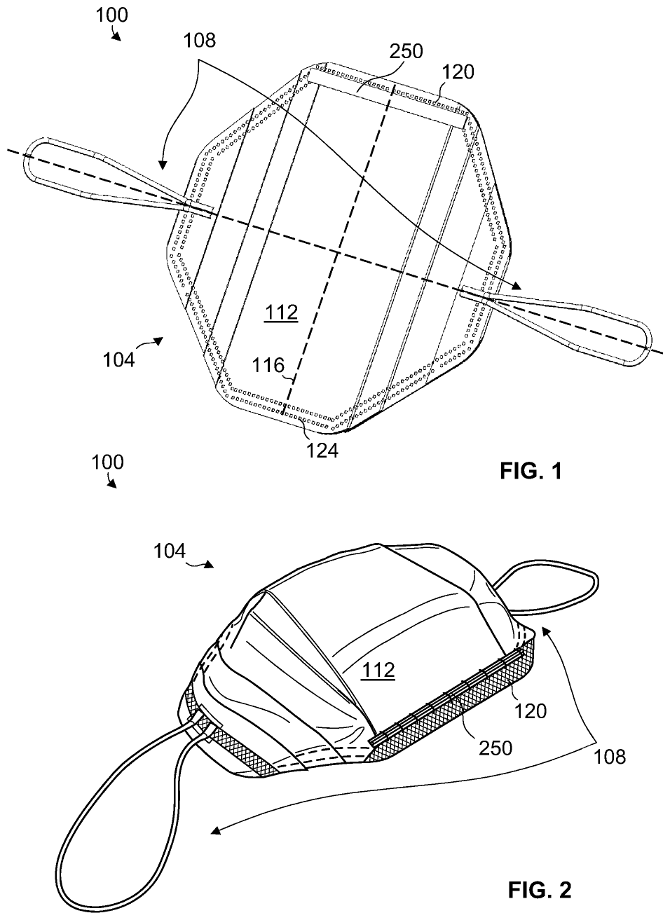

Referring now to FIGS. 1 and 2, illustrated therein is an example of a filter mask 100. The filter mask 100 has a mask body 104 shaped to cover a nose and a mouth of a wearer. The filter mask 100 also has a retainer system 108 to hold the mask body 104 to a head of the wearer over the nose and the mouth of the wearer.

As described further subsequently, the shape and/or arrangement of the mask body 104 and the retainer system 108 contribute to allowing the filter mask 100 to be transitioned from a flat configuration (FIG. 1) to a cup-shaped configuration (FIG. 2) with minimal tactile contact between the wearer and the mask body 104. The shape and/or arrangement of the mask body 104 and the retainer system 108 also or alternatively contribute to maintaining the filter mask 100 in the cup-shaped wearable configuration (FIG. 2) with minimal tactile contact between the wearer and the mask body 104.

The illustrated example mask body 104 is a flexible filtering mask body formed of a gas-permeable filter medium. The mask body 104 is shaped to cover a nose and a mouth of a user, and includes an outside surface 112 and an opposite inside surface 114 (FIG. 4).

As in the illustrated example, the filter mask 100 may be a flat mask, and may be a single generally planar panel in the first configuration (i.e. not a ‘duckbill’ mask formed of two panels joined together along edges thereof to form an openable pocket therebetween to be opened to cover the mouth and face of a user). As in the illustrated example, the mask body 104 may be configured to be loose-fitting over the nose and the mouth of the wearer (i.e. not including a respirator-style non-porous face seal to seal against the face of the wearer).

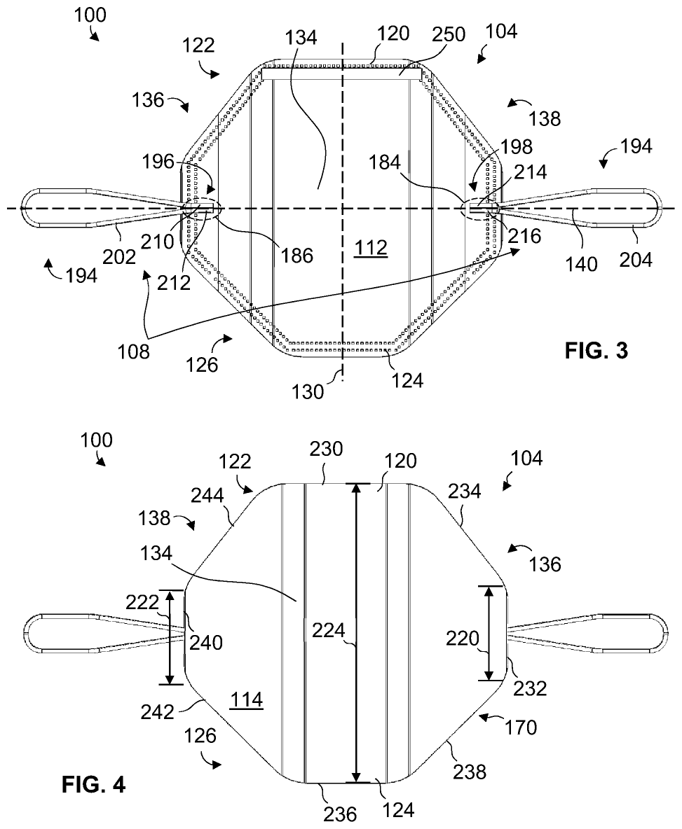

Referring now to FIGS. 3 and 4, the mask body 104 includes a top body portion 120 at a top body end 122 to be adjacent the nose of the user when the filter mask 100 is worn. The mask body 104 also includes a bottom body portion 124 at a bottom body end 126 to be adjacent a chin of the user when the filter mask is worn. The bottom body end 126 is spaced from the top body end 122 along a vertical axis 130 of the mask body 104. The bottom body end 126 is opposite the top body end 122 across the mask body 104.

The mask body 104 also includes a midbody portion 134 positioned between the top body end 122 and the bottom body end 126. The midbody portion 134 extends between a right body side 136 and a left body side 138 of the mask body 104. The left body side 138 is spaced from the right body side 136 along a horizontal axis 140 of the mask body 104, and is opposite the right body side 136 across the mask body 104. The midbody portion 134 is shaped to extend from the right body side 136 adjacent a right side of a face of a wearer to the left body side 138 adjacent a left side of the face of the wearer. The mask body 104 has a perimeter 170, and in some examples the mask body 104 is shaped such that the perimeter 170 may rest against the face of the user around the nose and mouth of the wearer (i.e. to prevent air from bypassing the mask body 104). Accordingly, air breathed in by the wearer may need to pass through the mask body 104, since the mask body 104 may be configured to conform to the face of the wearer when worn (i.e. leaving no gap between the perimeter 170 and the face of the wearer).

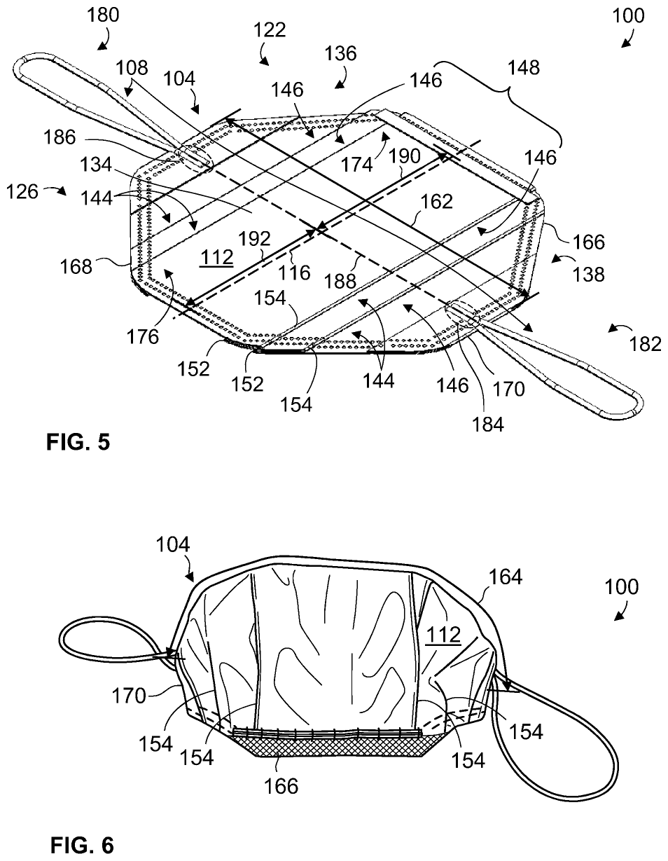

Referring now to FIG. 5, the illustrated example mask body 104 is pleated. Pleats may facilitate extending the midbody portion 134 between the first and second configurations. A pleat is a type of fold formed by doubling a flexible material (e.g. a fabric formed of a network of natural or artificial fibers) back upon itself and securing at least one end of the doubled material to prevent it from opening. The filtering mask body 104 may include a plurality of pleats 144, each pleat 144 of the plurality of pleats 144 extending between the top body end 122 and the bottom body end 126. As in the illustrated example, each pleat 144 of the plurality of pleats 144 may be a vertical pleat (i.e. extending generally parallel to the vertical axis 130 shown in FIG. 3). Vertical pleats may better facilitate the opening of the midbody portion 134 than angled pleats.

In the illustrated example, the plurality of pleats 144 is evenly distributed about a vertical centerline 116 of the mask body 104. Even distribution of pleats 144 may facilitate a cup shape (e.g., a symmetrical cup shape) in an opened configuration. A knife pleat is a sharply pressed pleat having three layers of fabric. In some examples, the filtering mask includes one or more knife pleat 146 and/or one or more box pleat group 148 (i.e. a pair of knife pleats 146 opening away from one another). The box pleat group 148 may be a central pleat group (i.e. extending along the vertical centerline 116), as illustrated.

In some examples, each pleat 144 of the plurality of pleats 144 includes an inner fold 152 and an outer fold 154. The outer fold 154 may be farther from the vertical centerline 116 of the filtering mask body 104 than the inner fold 152. The arrangement of the outer fold 154 farther from the vertical centerline 116 of the filtering mask body 104 may facilitate opening the cup shape of the open configuration outward rather than inward towards the face of the wearer adjacent the inside surface 114.

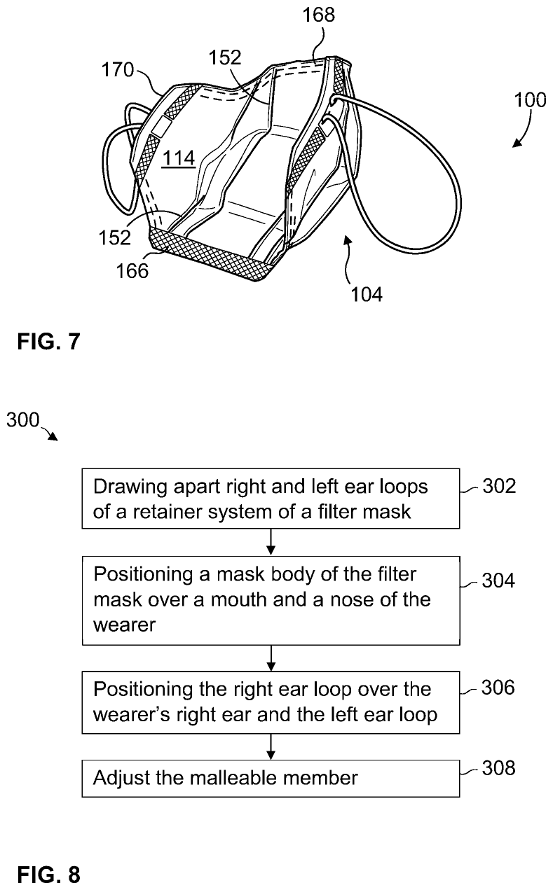

Referring now to FIGS. 5 to 7, the mask body 104 may have a first configuration (FIG. 5; i.e. the flat configuration) in which the filtering mask body 104 has a first horizontal extent 162 of the outside surface 112 along the midbody portion 134. The mask body 104 is movable between the first configuration and a second configuration (FIGS. 6 and 7; i.e. the open or cup shaped configuration) in which the filtering mask body 104 has a second horizontal extent 164 of the outside surface 112 along the midbody portion 134, the second extent 164 being greater than the first extent 162. In some examples, as in the illustrated example, the filtering mask body 104 is pleated in the first configuration, and the pleat(s) are at least partially opened in the second configuration.

The filter mask 100 may have one or more edge (e.g. perimeter portion) held in a fixed length, which may facilitate forming a cup shape when opening the midbody portion 134 (i.e. rather than simply extending the length of the mask body 104). In some examples, at least one of a top edge 166 along the top body end 122 and a bottom edge 168 along the bottom body end 126 has a first fixed length between the right body side 136 and the left body side 138 in both the first and second configurations. In some examples, the top edge 166 has the first fixed length and the bottom edge 168 has a second fixed length in both the first and second configurations. The first and second fixed lengths may be equal. In some examples, the perimeter 170 of the filtering mask body 104 has a fixed length in both the first and second configurations (i.e. the same fixed length in both configurations).

The fixed length may be maintained by preventing the pleats 144 from opening in portions or along edges having a fixed length. As in the illustrated example, each pleat 144 of the plurality of pleats 144 may have a top pleat end 174 at the top body end 122 and a bottom pleat end 176 at the bottom body end 126. The top pleat end 174 and the bottom pleat end 176 may be each secured in a pleated configuration (e.g. sown or glued or otherwise held shut) to prevent the top pleat end 174 and the bottom pleat end 176 from opening in the second configuration of the filtering mask body 104.

The retainer system 108 is secured to the filtering mask body 104. The retainer system 108 is shaped to hold the filtering mask body 104 to a head of the user over the nose and the mouth of the user with the top body end 122 above the bottom body end 126.

It has been discovered that drawing the mask body 104 open using only one location on each side may allow the mark body to open more easily into a cup-shaped configuration (FIGS. 6 and 7) and/or result in a more comfortable (e.g. stable) cup-shaped configuration. Further, drawing the mask open using the retainer system 108 reduces contact between the user and the mask body 104. The retainer system 108 has a right portion 180 and a left portion 182, and the right portion 180 and the left portion 182 may be moved apart to reconfigure the mask body 104 from the first configuration (FIG. 5) to the second configuration (FIGS. 6 and 7). The retainer system 108 is arranged to draw at only a single left-side location 184 on the left body side 138 and only a single right-side location 186 on the right body side 136 when the right portion 180 and the left portion 182 are moved apart to reconfigure the filtering mask body 104 from the first configuration to the second configuration. As in the illustrated example, the retainer system 108 may be attached to the mask body at only the right-side location 186 and the left-side location 184, although in some examples the retainer system 108 may be attached elsewhere but arranged to only draw on the left-side location and the right-side location. In the first configuration of the illustrated example, the left-side location 184 and the right-side location 186 are separated by a first distance that is at least 50% of the first horizontal extent 162 (although in some examples, the first distance may be less than 50%, such as at least 10%, at least 20%, or at least 40%).

The top body portion 120 and/or bottom body portion 124 of the filter mask 100 may be reinforced compared to the midbody portion 134 (e.g. reinforced by having a body panel folded over along the edge). The ends of ear loops or other retainer system elements may be secured to the mask body 104 at positions aligned with reinforced portions of the mask body 104 to draw the mask body open along reinforced portions (e.g. to prevent tearing or other damage). However, as in the illustrated example, in some examples the left-side location 184 and the right-side location 186 are not aligned with the top body portion 120 or the bottom body portion 124 to draw the mask body 104 open along a line through the top body portion 120 or the bottom body portion 124. Rather, the left-side location 184 and the right-side location 186 may be across the midbody portion 134 (e.g. diametrically opposed across the midbody portion 134). Accordingly, the midbody portion 134 can be drawn open along a midway line 188 (e.g. a horizontal midway line generally parallel to the horizontal axis) when the right portion 180 of the retainer system 108 and the left portion 182 of the retainer system 108 are moved apart. The midway line 188 runs across the midbody portion 134 between the right-side location 186 and the left-side location 184. The midway line 188 is spaced an upper allowance distance 190 from the top body end 122 and a lower allowance distance 192 from the bottom body end 126. The upper allowance distance 190 may be at least 20% (or at least 30% or at least 40%) of a center height 224 (FIG. 4) of the mask body 104. The lower allowance distance 192 may be at least 20% (or at least 30% or at least 40%) of the center height 224 of the mask body 104. As in the illustrated example, the midway line 188 may be a horizontal centerline (i.e. a horizontal line equally distant from the top end and bottom end) of the midbody portion 134, in that the upper allowance distance 190 is equal to the lower allowance distance 192 (although, in other examples, the midway line 188 may not be horizontal centerline, in that the upper allowance distance 190 may be greater than or less than the lower allowance distance 192).

Referring again to FIGS. 3 and 4, as in the illustrated example, the retainer system 108 may include at least one flexible strap 194. The at least one flexible strap 194 includes at least one right strap end 196 secured to the filtering mask body 104 at the right-side location 186 and at least one left strap end 198 secured to the filtering mask body 104 at the left-side location 184. In the illustrated example the at least one flexible strap 194 includes a right ear loop 202 and a left ear loop 204. The right ear loop 202 has a right first end 210 and a right second end 212, each of the right first end 210 and the right second end 212 secured to the filtering mask body 104 adjacent one another and at the right-side location 186. The left ear loop 204 has a left first end 214 and a left second end 216, the left first end 214 and the left second end 216 secured to the filtering mask body 104 adjacent one another and at the left-side location 184. In some examples, as in the illustrated example, the retainer system 108 consists of (i.e. no more than) the right ear loop 202 and the left ear loop 204.

In some examples, the left-side location 184 and the right-side location 186 are on the outside surface 112 of the mask body 104 (e.g. the right first end 210, the right second end 212, the left first end 214, and the left second end 216 are each secured to the outside surface 112 of the filtering mask body 104 and spaced from the perimeter 170). Securing the ends to the outside surface may facilitate opening the cup-shape outwards.

The filtering mask body 104 may have a non-rectangular perimeter 170 (e.g. rounded without 90 degree corners, such as with only corners having an interior obtuse angle). A non-rectangular perimeter 170 may better match the contours of the face of the wearer. Also, or alternatively, the perimeter 170 of the mask body 104 may be non-rectangular to reduce the occurrence of unanchored and/or free (i.e., not held against the user's face) portions of the mask body 104 and/or perimeter 170. With the retainer system 108 drawing the mask body 104 open from only a single location on each of the right and left sides of the mask body, a mask body having a rectangular perimeter 170 may have one or more free and/or unanchored corners when worn.

In some examples, a right height 220 of the filtering mask body 104 at the right body side 136 and a left height 222 of the filtering mask body 104 at the left body side 138 are each less than the center height 224 of the filtering mask body 104 along the vertical centerline 116 of the filtering mask body 104. As in the illustrated example, the perimeter 170 may be octagonal. In some examples, as illustrated, the top body portion 120 and/or top body end 122 is less rounded than the bottom body portion 124 and/or bottom body end 126.

As in the illustrated example, the perimeter 170 of the filter mask 100 may include a horizontally extending (i.e. generally parallel to the horizontal axis 140) upper portion 230, a vertically extending (i.e. generally parallel to the vertical axis 130) right portion 232, and a first angled (i.e. not horizontally or vertically extending) portion 234 joining the upper portion 230 and the right portion 232. The perimeter 170 may also include a horizontally extending lower portion 236, a second angled portion 238 joining the right portion 232 and the lower portion 236, a vertically extending left portion 240, a third angled portion 242 joining the lower portion 236 and the left portion 240, and a fourth angled portion 244 joining the left portion 240 and the upper portion 230. The upper portion 230 may be longer than the lower portion 236 (e.g. to facilitate use with a face of a user in which the chin is narrower than the upper face). The right portion 232 and the left portion 240 may be equal in length (e.g. to facilitate use with a face in which the distance between one ear and the chin and the other ear and the chin are roughly equal).

A malleable member 250 may be provided to assist the wearer in forming the top body portion 120 and/or top body end 122 into a shape that fits comfortably over the nose of the wearer.

Referring now to FIG. 8, a method 300 of applying a face mask may involve use of a face mask (e.g. filter mask 100 above) and includes, at step 302, drawing a right portion of a retainer system and a left portion of a retainer system apart to increase the outside surface horizontal extent of a mask body of the face mask. In some examples, the right portion is and/or includes the right ear loop and the left portion is and/or includes the left ear loop, and step 302 involves drawing the right ear loop of the face mask and the left ear loop of the face mask apart. As the right portion is secured to the mask body at the single right-side location and the left portion is secured to the mask body at the single left-side portion, step 302 involves drawing the mask body open along a single line, which may be the midway line 188. With the perimeter 170 of the mask body 104 prevented from opening, the mask body 104 may be formed into a cup shape, as described above.

Method 300 also includes, at step 304, positioning the filtering mask body over the nose and the mouth of the wearer. At step 306, method 300 involves positioning the right portion of the retainer system (e.g. right side ear loop) over a right ear of the user and the left portion of the retainer system (e.g. left side ear loop) over a left ear of the user. The method 300 may include, at step 308, adjusting a malleable member to configure the upper end to conform to a nose of a user (e.g. the malleable member 250).

The wearer may thus be able to open the filter mask 100 from the first configuration (FIG. 1) to the second configuration (FIG. 2) by drawing apart the right portion 180 and the left portion 182 of the retainer system 108 without otherwise touching the mask body 104. Further, the wearer may be able to put on the filter mask 100 by securing the right portion 180 and the left portion 182 to the user's head and adjusting the malleable member, without otherwise touching the mask body. The filter mask 100 thus in the second configuration (FIG. 2) may rest comfortably over the user's mouth and nose. The rounded perimeter 170 (e.g. having no corners) of the mask body 104 may assist in preventing corners of the mask body 104 from interfering with the second configuration.

The present invention has been described here by way of example only. Various modification and variations may be made to these examples without departing from the scope of the invention, which is limited only by the appended claims.

1. A filter mask for covering a nose and a mouth of a user, comprising:
a flexible mask body formed of a gas-permeable filter medium and shaped to cover the nose and the mouth of the user, the mask body having:
a top body portion at a top body end to be adjacent the nose of the user when the filter mask is worn,
a bottom body portion at a bottom body end opposite the top body end to be adjacent a chin of the user when the filter mask is worn,
a midbody portion positioned between the top body end and the bottom body end and extending between a right body side and a left body side opposite the right body side,
a plurality of pleats, each pleat having a top pleat end at the top body end and bottom pleat end at the bottom body end and extending between the top body end and the bottom body end across the midbody portion, each pleat having at least one of the top pleat end and the bottom pleat end fixed shut, and each pleat openable in the midbody portion, and
wherein the filtering mask body is extendable between a first configuration in which each of the plurality of pleats are closed in the midbody portion and the mask body has a first horizontal extent of the outside surface along the midbody portion and a second configuration in which the plurality of pleats are open in the midbody portion and the mask body has a second horizontal extent of the outside surface along the midbody portion, the second extent being greater than the first extent; and
a retainer system to retain the filter mask on the head of the user, the retainer system secured to the mask body only at a single right-side location and a single left-side location, the retainer system including at least one flexible strap including at least one right strap end secured to the filtering mask body at the right-side location, and the at least one flexible strap including at least one left strap end secured to the filtering mask body at the left-side location.

2. The filter mask of claim 1, wherein each of the top pleat end and the bottom pleat end of each pleat is fixed shut, and each pleat is openable in the midbody portion.

3. The filter mask of claim 1, wherein the left-side location and the right-side location are diametrically opposed across the midbody portion such that the midbody portion is drawn open along a horizontal midway line running across the midbody portion between the right-side location and the left-side location when the right-side location and the left-side location are moved apart.

4. The filter mask of claim 3, wherein the midway line is a horizontal centerline of the midbody portion, spaced an equal distance from the top body end and the bottom body end.

5. The filter mask of claim 1, wherein the at least one flexible strap includes a right ear loop and a left ear loop, the right ear loop having right first and second ends secured to the filtering mask body adjacent one another and at the right-side location, and the left ear loop having left first and second ends secured to the filtering mask body adjacent one another and at the left-side location.

6. The filter mask of claim 5, wherein the right first and second ends and the left first and second ends are secured to the outside face of the filtering mask body.

7. The filter mask of claim 5, wherein the retainer system consists only of the right ear loop and the left ear loop.

8. The filter mask of claim 1, wherein the mask body is a single generally planar panel in the first configuration with the left-side location and the right-side location separated by a distance that is at least 50% of the first horizontal extent, and the mask body is configured to be loose-fitting over the nose and the mouth of the user.

9. The filter mask of claim 1, wherein the mask body has a vertical axis along which the top body portion and the bottom body portion are separated, and each pleat is a vertical pleat parallel to the vertical axis, and the plurality of pleats are evenly distributed about a vertical center line of the mask body.

10. The filter mask of claim 1, wherein each pleat of the plurality of pleats includes an inner fold and an outer fold farther from a vertical centerline of the filtering mask body than the inner fold.

11. A filter mask for covering a nose and a mouth of a user, comprising:
a flexible mask body formed of a gas-permeable filter medium and shaped to cover the nose and the mouth of the user, the mask body having an outside surface and an opposite inside surface, the mask body having:
a top body portion at a top body end to be adjacent the nose of the user when the filter mask is worn,
a bottom body portion at a bottom body end opposite the top body end to be adjacent a chin of the user when the filter mask is worn, and
a midbody portion positioned between the top body end and the bottom body end and extending between a right body side and a left body side opposite the right body side, and
wherein the mask body is extendable between a first configuration in which the mask body has a first horizontal extent of the outside surface along the midbody portion and a second configuration in which the mask body has a second horizontal extent of the outside surface along the midbody portion, the second extent being greater than the first extent; and
a retainer system secured to the mask body and shaped to retain the mask body to a head of the user over the nose and the mouth of the user with the top body end above the bottom body end,
wherein the retainer system is attached to the mask body and arranged to draw at only a single left-side location on the left body side and only a single right-side location on the right body side when a right portion of the retainer system and a left portion of the retainer system are moved apart to reconfigure the mask body from the first configuration to the second configuration.

12. The filter mask of claim 11, wherein at least one of a top edge of the outside surface along the top body end and a bottom edge of the outside surface along the bottom body end has a first fixed length in both the first and second configurations.

13. The filter mask of claim 12, wherein the top edge has the first fixed length in both the first and second configurations, and the bottom edge has a second fixed length in both the first and second configurations.

14. The filter mask of claim 11, wherein a perimeter of the filtering mask body has a fixed length in both the first and second configurations.

15. The filter mask of claim 11, wherein the left-side location and the right-side location are diametrically opposed across the midbody portion such that the midbody portion is drawn open along a horizontal midway line running across the midbody portion between the right-side location and the left-side location when the right portion of the retainer system and the left portion of the retainer system are moved apart.

16. The filtering mask of claim 11, wherein the retainer system includes at least one flexible strap, the at least one flexible strap including at least one right strap end secured to the filtering mask body at the right-side location, and the at least one flexible strap including at least one left strap end secured to the filtering mask body at the left-side location.

17. The filter mask of claim 11, wherein the left-side location and the right-side location are separated in the first configuration by a first distance that is at least 50% of the first horizontal extent.

18. The filter mask of claim 11, wherein the filtering mask body includes a plurality of pleats, each pleat of the plurality of pleats extending between the top body end and the bottom body end.

19. The filter mask of claim 11, wherein a right height of the filtering mask body at the right side and a left height of the filtering mask body at the left side are each less than a center height of the filtering mask body along a vertical center line of the filtering mask body.

20. A method of applying a face mask, comprising:
providing the face mask having a mask body of a flexible gas-permeable filter medium, a right ear loop secured to the mask body at a single-right-side location, and a left ear loop secured to the mask body at a single left-side location, the mask body extendable horizontally when drawn from the single right-side location and the single left-side location;
drawing the right ear loop and the left ear loop apart to increase an outside surface horizontal extent of the mask body;
positioning the filtering mask body over a nose and a mouth of a user; and
positioning the right side ear loop over a right ear of the user and the left side ear loop over a left ear of the user.
